(19) United States
(12) Patent Application Publication
(10) Pub. No.: US 2024/0078107 A1
(43) Pub. Date: Mar. 7, 2024

(54) PERFORMING QUALITY-BASED ACTION(S) REGARDING ENGINEER-GENERATED DOCUMENTATION ASSOCIATED WITH CODE AND/OR APPLICATION PROGRAMMING INTERFACE

(71) Applicant: Microsoft Technology Licensing, LLC, Redmond, WA (US)

(72) Inventors: Anurag GUPTA, Sammamish, WA (US); Chetan BANSAL, Seattle, WA (US); Manish Shetty MOLAHALLI, Bangalore (IN)

(21) Appl. No.: 17/458,417

(22) Filed: Aug. 26, 2021

(51) Int. Cl. G06F 8/73; G06F 40/40

(52) U.S. Cl. CPC G06F 8/73; G06F 40/40

(57) ABSTRACT

Techniques are described herein that are capable of performing quality-based action(s) regarding engineer-generated documentation associated with code and/or an API. Features are extracted from data associated with the engineer-generated documentation, which includes engineer-generated document(s). Weights are assigned to the features. The quality-based action(s) are performed. The quality-based action(s) include generating quality score(s) for the engineer-generated document(s) and/or providing a recommendation to revise a subset of the engineer-generated document(s). Each quality score is based at least in part on the weights assigned to the features that correspond to the respective engineer-generated document. The recommendation recommends performance of an operation to increase the quality of each engineer-generated document in the subset based at least in part on the weights assigned to the features that correspond to the subset.

### BACKGROUND

A variety of engineers may be associated with code or with an application programming interface (API). An engineer is defined herein to be a person who is a practitioner of engineering. An engineer need not necessarily have an engineering degree. Examples of an engineer include but are not limited to a developer who develops at least a portion (e.g., all) of the code or the API; a product manager who manages development of a product that includes the code or the API; a program manager who manages multiple related projects, at least one of which is associated with the code or the API; and an on-call engineer (a.k.a. directly responsible individual) who monitors execution of the code or utilization of the API. Any such engineer may generate documentation associated with the code or the API. Documentation that is generated by one or more engineers is referred to herein as “engineer-generated documentation.”

Engineer-generated documentation associated with code or an API often is of a relatively low quality. For instance, the engineer-generated documentation often is incomplete, includes errors, and/or includes subjective (e.g., ambiguous) language. The relatively low quality of the engineer-generated documentation may negatively affect productivity of engineers who use the engineer-generated documentation, increase a cost of performing operations using the engineer-generated documentation, and/or lead to an outage of the code or the API with which the engineer-generated documentation is associated. Engineers may perform ad hoc changes to the engineer-generated documentation in an effort to increase the quality of the engineer-generated documentation. However, the ad hoc changes may not be optimized, safe, or secure.

### SUMMARY

Various approaches are described herein for, among other things, performing quality-based action(s) regarding engineer-generated documentation associated with code (e.g., a service) and/or an application programming interface (API). The engineer-generated documentation includes one or more engineer-generated documents. A quality-based action regarding an engineer-generated document indicates (e.g., identifies) quality of the engineer-generated document and/or facilitates increasing the quality. The quality of an engineer-generated document represents a degree of excellence of the engineer-generated document or a superiority in kind of the engineer-generated document. The quality of the engineer-generated document may be based on any of a variety of factors, including but not limited to utility, ease of use (e.g., clarity, conciseness), reputation (e.g., among users of the engineer-generated document), and accuracy of the engineer-generated document.

Examples of an engineer-generated document include but are not limited to a troubleshooting guide, a readme file, an onboarding guide, and a file shared among members of an engineering team associated with the code. A troubleshooting guide is usable to diagnose and/or resolve issues regarding the code and/or the API. An example of such an issue is a bug (e.g., defect) in the code and/or the API. For instance, the bug may be encountered during execution of the code or during utilization of the API. Another example of such an issue is an infrastructure-related problem encountered by the code and/or the API. For instance, a service may not be operational because a network device has gone down. A readme file includes information about other file(s) that are included in a directory or archive of the code and/or the API. An onboarding guide describes features of the code and/or the API to users of the code and/or the API. For instance, the onboarding guide may familiarize the users with how the code and/or the API functions and/or guide the users through how to use the code and/or the API.

In an example approach of performing quality-based action(s) regarding engineer-generated documentation associated with code and/or an API, features are extracted from data associated with the engineer-generated documentation. The engineer-generated documentation includes engineer-generated document(s). For instance, each feature may indicate an attribute of at least one engineer-generated document. Weights are assigned to the respective features. The quality-based action(s) are performed based at least in part on the weights that are assigned to the respective features. The quality-based action(s) include generating quality score(s) for the respective engineer-generated document(s) and/or providing a recommendation to revise a subset of the engineer-generated document(s) based at least in part on the weights assigned to the respective features that correspond to the subset. Each quality score is based at least in part on the weights assigned to the respective features that correspond to the respective engineer-generated document. For instance, each quality score may represent a quality of the respective engineer-generated document. The recommendation recommends performance of an operation that is configured to increase the quality of each engineer-generated document in the sub set.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example quality-based action system in accordance with an embodiment.

FIGS. 2A-2B depict respective portions of a flowchart of an example method for performing quality-based action(s) regarding engineer-generated documentation associated with code and/or an application programming interface (API) in accordance with an embodiment.

FIG. 3 is a block diagram of an example computing system in accordance with an embodiment.

FIGS. 4 and 6 depict example troubleshooting guides associated with code and/or an API in accordance with embodiments.

FIG. 5 depicts an example result of performing quality-based actions regarding the troubleshooting guide shown in FIG. 4 in accordance with an embodiment.

FIG. 7 depicts an example result of performing quality-based actions regarding the troubleshooting guide shown in FIG. 6 in accordance with an embodiment.

FIG. 8 depicts an example graphical user interface that solicits explicit feedback from a user of an engineer-generated document in accordance with an embodiment.

FIG. 9 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

### II. Example Embodiments

Example embodiments described herein are capable of performing quality-based action(s) regarding engineer-generated documentation associated with code (e.g., a service) and/or an application programming interface (API). The engineer-generated documentation includes one or more engineer-generated documents. A quality-based action regarding an engineer-generated document indicates (e.g., identifies) quality of the engineer-generated document and/or facilitates increasing the quality. The quality of an engineer-generated document represents a degree of excellence of the engineer-generated document or a superiority in kind of the engineer-generated document. The quality of the engineer-generated document may be based on any of a variety of factors, including but not limited to utility, ease of use (e.g., clarity, conciseness), reputation (e.g., among users of the engineer-generated document), and accuracy of the engineer-generated document.

Examples of an engineer-generated document include but are not limited to a troubleshooting guide, a readme file, an onboarding guide, and a file shared among members of an engineering team associated with the code. A troubleshooting guide is usable to diagnose and/or resolve issues regarding the code and/or the API. An example of such an issue is a bug (e.g., defect) in the code and/or the API. For instance, the bug may be encountered during execution of the code or during utilization of the API. Another example of such an issue is an infrastructure-related problem encountered by the code and/or the API. For instance, a service may not be operational because a network device has gone down. A readme file includes information about other file(s) that are included in a directory or archive of the code and/or the API. An onboarding guide describes features of the code and/or the API to users of the code and/or the API. For instance, the onboarding guide may familiarize the users with how the code and/or the API functions and/or guide the users through how to use the code and/or the API.

Example techniques described herein have a variety of benefits as compared to conventional techniques for managing engineer-generated documentation. For instance, the example techniques may be capable of increasing the quality of engineer-generated documentation. By increasing the quality of the engineer-generated documentation, the example techniques may increase productivity of users who use the engineer-generated documentation, reduce a cost of performing operations using the engineer-generated documentation, reduce a likelihood that the code and/or the API with which the engineer-generated documentation is associated will experience an outage, and/or enable deployment of the code and/or utilization of the API to be scaled in a production environment. The example techniques may standardize a structure of engineer-generated documents, automatically measure the quality of the engineer-generated documents, and automatically provide usage insights regarding how the engineer-generated documents are being used and issues that are encountered with regard to the engineer-generated documents.

The example techniques may increase security of the engineer-generated documentation and the code and/or the API with which the engineer-generated documentation is associated. For instance, the example techniques may reduce a need for an engineer to make an ad hoc change to the engineer-generated documentation in an effort to increase the quality of the engineer-generated documentation. By reducing the need for the engineer to make the ad hoc change, negative impacts of the ad hoc change on the optimization, safety, and/or security of the engineer-generated documentation may be avoided. By increasing the quality of the engineer-generated documentation, the example techniques may reduce a likelihood of a user who uses the engineer-generated documentation to perform an operation that damages the code and/or the API (e.g., compromises security or functionality of the code and/or the API). Accordingly, the example techniques may increase security of a computing system that executes the code and/or that utilizes the API.

By increasing the quality of the engineer-generated documentation, the example techniques may improve (e.g., increase) a user experience of a user who uses the engineer-generated documentation, increase efficiency of the user, and/or reduce a cost associated with the user using the engineer-generated documentation to perform operations regarding (e.g., on) the code and/or the API. The example techniques may be more efficient, reliable, and/or effective than conventional techniques for managing engineer-generated documentation, for example, by increasing thoroughness and/or accuracy of the engineer-generated documentation.

The example techniques may reduce an amount of time and/or resources (e.g., processor cycles, memory, network bandwidth) that is consumed to use engineer-generated documentation to perform operations regarding code and/or the API. For instance, by increasing the quality of the engineer-generated documentation, a computing system may conserve the time and resources that would have been consumed by the computing system to execute instructions initiated by a user to figure out which operations are to be performed with regard to the code and/or the API and/or to execute instructions to remedy the effects of undesirable operations being performed as a result of the engineer-generated documentation not being sufficiently thorough.

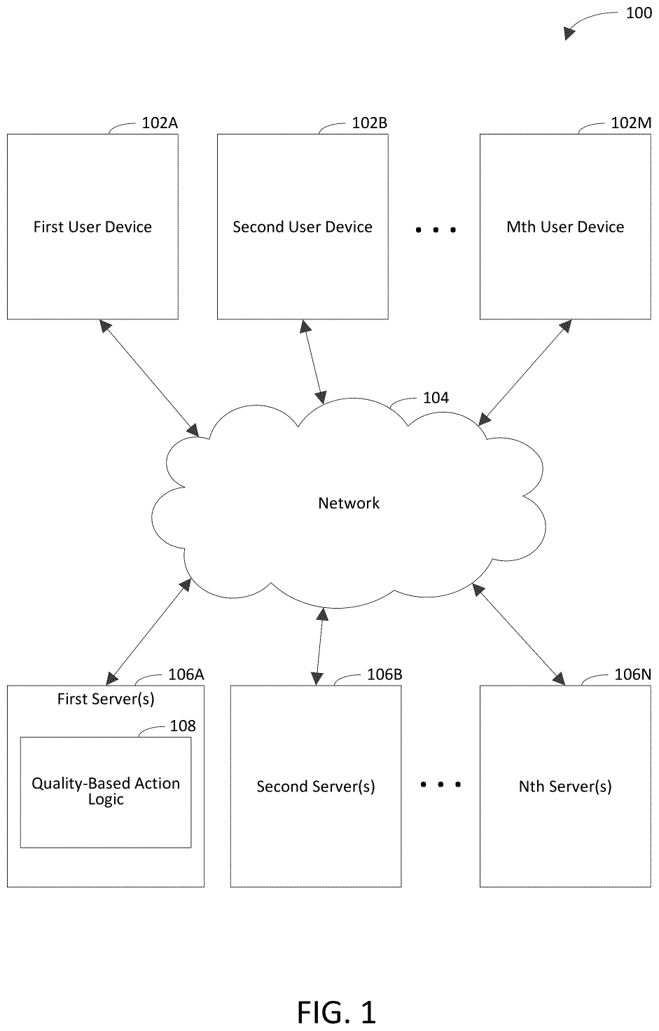

FIG. 1 is a block diagram of an example quality-based action system 100 in accordance with an embodiment. Generally speaking, the quality-based action system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the quality-based action system 100 performs quality-based action(s) regarding engineer-generated documentation associated with code and/or an API. Detail regarding techniques for performing quality-based action(s) regarding engineer-generated documentation associated with code and/or an API is provided in the following discussion.

As shown in FIG. 1, the quality-based action system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are processing systems that are capable of communicating with servers 106A-106N. An example of a processing system is a system that includes at least one processor that is capable of manipulating data in accordance with a set of instructions. For instance, a processing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are processing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the quality-based action system 100.

One example type of computer program that may be executed by one or more of the servers 106A-106N is a developer tool. A developer tool is a computer program that performs diagnostic operations (e.g., identifying source of problem, debugging, profiling, controlling, etc.) with respect to program code and/or an API. Examples of a developer tool include but are not limited to a web development platform (e.g., Windows Azure Platform®, Amazon Web Services®, Google App Engine®, VMWare®, Force.com®, etc.) and an integrated development environment (e.g., Microsoft Visual Studio®, JDeveloper®, NetBeans®, Eclipse Platform™, etc.). It will be recognized that the example techniques described herein may be implemented using a developer tool.

The first server(s) 106A are shown to include quality-based action logic 108 for illustrative purposes. The quality-based action logic 108 is configured to perform quality-based action(s) regarding engineer-generated documentation associated with code and/or an API. For instance, the quality-based action logic 108 extracts features from data associated with the engineer-generated documentation. The engineer-generated documentation includes engineer-generated document(s). For example, each feature may indicate an attribute of at least one engineer-generated document. The quality-based action logic 108 assigns weights to the respective features. The quality-based action logic 108 performs the quality-based action(s) based at least in part on the weights that are assigned to the respective features. The quality-based action(s) include generating quality score(s) for the respective engineer-generated document(s) and/or providing a recommendation to revise a subset of the engineer-generated document(s) based at least in part on the weights assigned to the respective features that correspond to the subset. Each quality score is based at least in part on the weights assigned to the respective features that correspond to the respective engineer-generated document. For instance, each quality score may represent a quality of the respective engineer-generated document. The recommendation recommends performance of an operation that is configured to increase the quality of each engineer-generated document in the subset.

The quality-based action logic 108 may use machine learning (ML) to perform at least some of its operations. For instance, the quality-based action logic 108 may use the machine learning to develop and refine the features that are extracted from the data associated with the engineer-generated documentation. The quality-based action logic 108 may use the machine learning to analyze the data to identify attribute(s) of each engineer-generated document that are indicated (e.g., specified) by the engineer-generated documentation, to determine which attributes are shared by which engineer-generated documents, to derive the features from respective subsets of the attributes, and to identify the engineer-generated document(s) associated with each feature based on each of those engineer-generated document(s) having at least one attribute that is included in the subset from which the respective feature is derived.

The quality-based action logic 108 may use a neural network to perform the machine learning to predict values of respective attributes of the engineer-generated document(s). The quality-based action logic 108 may use the attributes to predict values of the features. Examples of a neural network include but are not limited to a feed forward neural network and a long short-term memory (LSTM) neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the quality-based action logic 108 employs a feed forward neural network to train a machine learning model that is used to determine ML-based confidences. Such ML-based confidences may be used to determine likelihoods that events will occur.

An LSTM neural network is a recurrent neural network that has memory and allows data to flow forward and backward in the neural network. The LSTM neural network is capable of remembering values for short time periods or long time periods. Accordingly, the LSTM neural network may keep stored values from being iteratively diluted over time. In one example, the LSTM neural network may be capable of storing information, such as historical values of respective attributes of engineer-generated documents and/or historical values of respective features over time. For instance, the LSTM neural network may generate an attribute model and/or a feature model by utilizing such information. In another example, the LSTM neural network may be capable of remembering relationships (e.g., relationships between attributes and/or features) and ML-based confidences that are derived therefrom.

The quality-based action logic 108 may include training logic and inference logic. The training logic is configured to train a machine learning algorithm that the inference logic uses to determine (e.g., infer) the ML-based confidences. For instance, the training logic may provide sample attributes, sample features, sample probabilities that respective attributes correspond to each feature, and sample confidences as inputs to the algorithm to train the algorithm. The sample data may be labeled. The machine learning algorithm may be configured to derive relationships between the attributes and/or features and the resulting ML-based confidences. The inference logic is configured to utilize the machine learning algorithm, which is trained by the training logic, to determine the ML-based confidence when the data associated with the engineer-generated documentation is provided as input to the algorithm.

The quality-based action logic 108 may be implemented in various ways to perform quality-based action(s) regarding engineer-generated documentation associated with code and/or an API, including being implemented in hardware, software, firmware, or any combination thereof. For example, the quality-based action logic 108 may be implemented as computer program code configured to be executed in one or more processors. In another example, at least a portion of the quality-based action logic 108 may be implemented as hardware logic/electrical circuitry. For instance, at least a portion of the quality-based action logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

The quality-based action logic 108 may be partially or entirely incorporated in a developer tool, such as a web development platform or an integrated development environment, though the example embodiments are not limited in this respect.

The quality-based action logic 108 is shown to be incorporated in the first server(s) 106A for illustrative purposes and is not intended to be limiting. It will be recognized that the quality-based action logic 108 (or any portion(s) thereof) may be incorporated in any one or more of the user devices 102A-102M. For example, client-side aspects of the quality-based action logic 108 may be incorporated in one or more of the user devices 102A-102M, and server-side aspects of quality-based action logic 108 may be incorporated in the first server(s) 106A. In another example, the quality-based action logic 108 may be distributed among the user devices 102A-102M. In yet another example, the quality-based action logic 108 may be incorporated in a single one of the user devices 102A-102M. In another example, the quality-based action logic 108 may be distributed among the server(s) 106A-106N. In still another example, the quality-based action logic 108 may be incorporated in a single one of the servers 106A-106N.

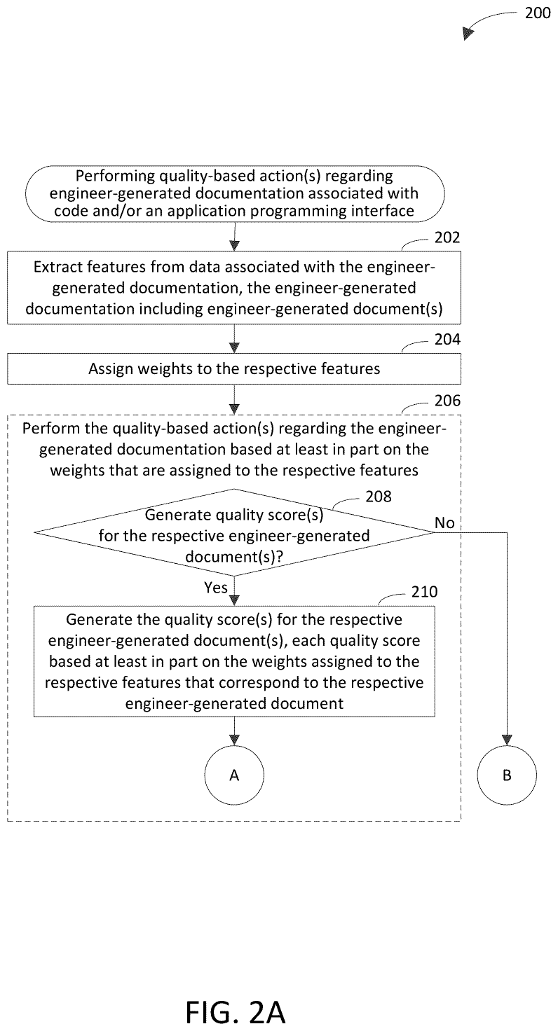

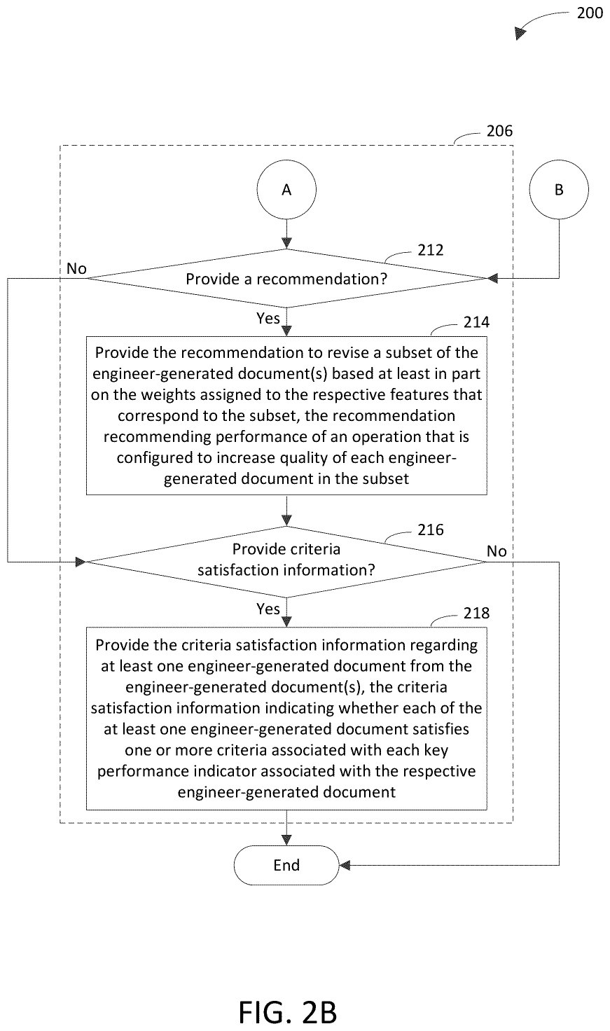

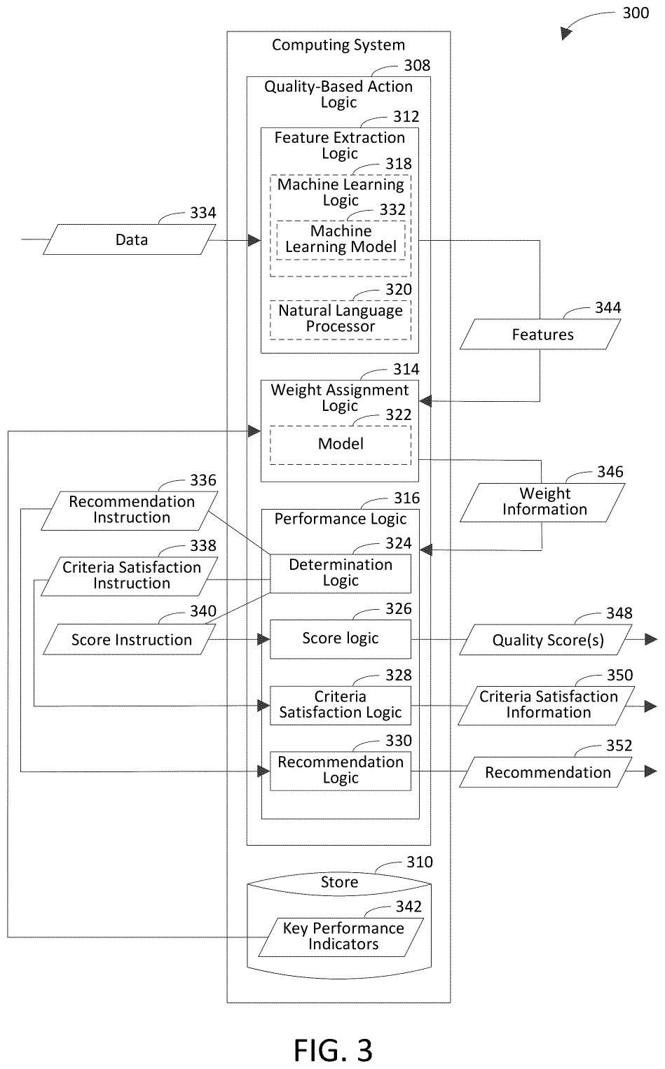

FIGS. 2A-2B depict respective portions of a flowchart 200 of an example method for performing quality-based action(s) regarding engineer-generated documentation associated with code and/or an application programming interface (API) in accordance with an embodiment. Flowchart 200 may be performed by the first server(s) 106A, shown in FIG. 1, for example. For illustrative purposes, flowchart 200 is described with respect to computing system 300 shown in FIG. 3, which is an example implementation of the first server(s) 106A. As shown in FIG. 3, the computing system 300 includes quality-based action logic 308 and a store 310. The quality-based action logic 308 includes feature extraction logic 312, weight assignment logic 314, and performance logic 316. The feature extraction logic 312 includes machine learning logic 318 and a natural language processor 320. The performance logic 316 includes determination logic 324, score logic 326, criteria satisfaction logic 328, and recommendation logic 330. The store 310 may be any suitable type of store. One type of store is a database. For instance, the store 310 may be a relational database, an entity-relationship database, an object database, an object relational database, an extensible markup language (XML) database, etc. The store 310 is shown to store key performance indicators 342 for non-limiting illustrative purposes. Further structural and operational embodiments will be apparent to persons skilled in the relevant art(s) based on the discussion regarding flowchart 200.

As shown in FIG. 2A, the method of flowchart 200 begins at step 202. In step 202, features are extracted from data associated with the engineer-generated documentation. The engineer-generated documentation includes engineer-generated document(s). Each feature indicates an attribute of at least one engineer-generated document from the engineer-generated document(s). In an example implementation, the feature extraction logic 312 extracts features 344 from data 334 that is associated with the engineer-generated documentation. In accordance with this implementation, each of the features 344 indicates attribute(s) of at least one engineer-generated document that is included in the engineer-generated documentation.

The data associated with the engineer-generated documentation may include explicit information, implicit information, and/or content information. Explicit information is information that is specified by user(s) of at least one engineer-generated document in the engineer-generated documentation. Examples of explicit information associated with an engineer-generated document include but are not limited to a positive (e.g., “thumbs up” or “like”) tag, a positive comment (e.g., “This document is succinct yet thorough”), a negative (e.g., “thumbs down” or “dislike”) tag, and a negative comment (e.g., “You will need to perform these extra steps that are missing from the document”) regarding the document that is received from a user of the document.

Implicit information is information that is derived from use of at least one engineer-generated document in the engineer-generated documentation and is not specified by user(s) of at least one engineer-generated document in the engineer-generated documentation. Examples of implicit information associated with an engineer-generated document include but are not limited to a number of times the document is viewed, an amount of time (e.g., average time) that users of the document dwell on the document, an extent (e.g., average extent) to which users of the document scroll within the document, an amount of time that is consumed to resolve an issue that a user uses the document to resolve, and a number of users (e.g., daily active users or monthly active users) of the document.

Content information is information that indicates characteristic(s) of content (e.g., structure) of at least one engineer-generated document in the engineer-generated documentation. Examples of content information include but are not limited to usability (e.g., readability) of the document, completeness of the document, correctness of the document, whether the document is nested in another document, whether the document includes a nested document, ambiguity of the document (e.g., an extent of subjective information that is included in the document), an amount of time since the document was created, an amount of time since the document was most recently updated, whether the document is empty, a length of the document, whether the document includes contact information of an entity that provides support to users of the document, a number of commands that are included in the document, whether the document includes executable code or a pointer to executable code, a number of links that are included in the document, whether the document includes nested lists, a number of tables that are include in the document, and a number of acronyms that are included in the document.

A feature extracted from the data associated with the engineer-generated documentation may indicate that each engineer-generated document associated with the feature (1) has a number of positive tags, positive comments, negative tags, negative comments, or users that is within a specified range of numbers; (2) is viewed a number of times that is within a specified range of numbers; (3) has a dwell time (e.g., average dwell time) that is within a specified range of dwell times; (4) has a scroll time (e.g., average scroll time) that is within a specified range of scroll times; (5) is used to resolve an issue for a period of time that is within a specified range of time periods; (6) has a usability, completeness, correctness, or ambiguity that is within a specified range of values; (7) is nested within another document; (8) includes a nested document; (9) was created or last updated at a time instance that is within a specified period of time in the past; (10) is empty; (11) has a length that is within a specified range of lengths; (12) includes contact information of a support entity; (13) includes a number of commands, links, tables, or acronyms that is within a specified range of numbers; (14) includes executable code or a pointer to executable code; (15) includes a nested list or a number of nested lists that is within a specified range of numbers, and so on.

In an example embodiment, the engineer-generated document(s) are troubleshooting guide(s). In accordance with this embodiment, each troubleshooting guide includes instructions that describe operations to be performed to resolve issues associated with the code and/or the API. For example, any one or more of the issues may be a bug (e.g., defect) in the code and/or the API. In another example, any one or more of the issues may be an infrastructure-related problem encountered by the code and/or the API.

In another example embodiment, the data associated with the engineer-generated documentation is stored across multiple independent clouds. Each of the independent clouds may be a public cloud or a private cloud. A public cloud is a cloud that is accessible to the general public. A private cloud is a cloud that is not accessible to the general public. For instance, access to the private cloud may be limited to only specified people or specified groups of people.

In yet another example embodiment, extracting the features at step 202 includes executing code that is included in an engineer-generated document that is included in the engineer-generated documentation to extract at least one of the features from the data associated with the engineer-generated documentation.

In still another example embodiment, extracting the features at step 202 includes extracting the features from the data using a machine learning model. The machine learning model is configured to receive the data as input to the machine learning model and is further configured to derive the features as outputs of the machine learning model based on the data. For instance, the machine learning logic 318 may extract the features 344 using a machine learning model 332 that is configured to receive the data 334 as input to the machine learning model 332 and that is further configured to derive the features 344 as outputs of the machine learning model 332 based on the data 334.

In an example embodiment, extracting the features at step 202 includes extracting a feature that indicates a readability of each of at least one engineer-generated document from the engineer-generated document(s). For instance, extracting the feature may include causing a Flesch-Kincaid readability test to be performed (e.g., performing the Flesch-Kincaid readability test) on each of the at least one engineer-generated document from which the feature is extracted. Readability of an engineer-generated document may be based on (e.g., based at least in part on) a number of acronyms, tables, and/or nested lists in the engineer-generated document. For instance, a relatively greater number of acronyms, tables, and/or nested lists in the engineer-generated document may result in the engineer-generated document having a relatively lower readability. A relatively lesser number of acronyms, tables, and/or nested lists in the engineer-generated document may result in the engineer-generated document having a relatively greater readability.

In another example embodiment, extracting the features at step 202 includes extracting a feature that indicates a number of users who use each of at least one engineer-generated document from the engineer-generated document(s).

In yet another example embodiment, extracting the features at step 202 includes extracting a feature that indicates a number of times each of at least one engineer-generated document from the engineer-generated document(s) is viewed.

In still another example embodiment, extracting the features at step 202 includes extracting a feature that indicates an amount of time that users of each of at least one engineer-generated document from the engineer-generated document(s) dwell on the respective engineer-generated document.

In an example embodiment, extracting the features at step 202 includes extracting a feature that indicates an extent to which users of each of at least one engineer-generated document from the engineer-generated document(s) scroll on the respective engineer-generated document.

In another example embodiment, extracting the features at step 202 includes extracting a feature that indicates an extent to which language in each of at least one engineer-generated document from the engineer-generated document(s) is subjective (e.g., non-definitive) by analyzing the data that is included in the respective engineer-generated document using natural language processing. For example, the feature extraction logic 312 may extract the feature by analyzing the data (e.g., natural language data) that is included in each of the at least one engineer-generated document using the natural language processing. In accordance with this example, the feature extraction logic 312 may use a natural language processor 320 to extract the feature. The natural language processor 320 may be configured to understand the data and nuances of the language in the data. In one aspect, the natural language processor 312 may be configured to automatically learn rules that are to be applied when analyzing the data. For instance, the natural language processor 320 may use statistical inference algorithms to generate model(s) that are robust to unfamiliar input and to erroneous input. In another aspect, the rules may be handwritten.

In yet another example embodiment, extracting the features at step 202 includes extracting a feature that indicates an amount of time since each of at least one engineer-generated document from the engineer-generated document(s) was created or updated. For instance, the feature may indicate whether the amount of time is greater than or equal to a threshold amount of time. It will be recognized that “freshness” of an engineer-generated document may be inversely proportional to the amount of time since the engineer-generated document was created or last updated.

In still another example embodiment, extracting the features at step 202 includes extracting a feature that indicates explicit feedback regarding each of at least one engineer-generated document from the engineer-generated document(s) from users of the respective engineer-generated document. For instance, the explicit feedback regarding each of the at least one engineer-generated document may include subjective ratings of the respective engineer-generated document from the respective users of the respective engineer-generated document.

In an example embodiment, extracting the features at step 202 includes extracting a feature that indicates that at least one engineer-generated document from the engineer-generated document(s) is empty.

In another example embodiment, extracting the features at step 202 includes extracting a feature that indicates that at least one engineer-generated document from the engineer-generated document(s) has a length that is greater than or equal to a length threshold.

In yet another example embodiment, extracting the features at step 202 includes extracting a feature that indicates whether an engineer-generated document from the engineer-generated document(s) includes contact information of a person or a group of persons to be contacted for assistance with the engineer-generated document.

In still another example embodiment, extracting the features at step 202 includes extracting a feature that indicates whether each of at least one engineer-generated document from the engineer-generated document(s) includes a number of commands that is greater than or equal to a threshold number.

In an example embodiment, extracting the features at step 202 includes extracting a feature that indicates whether each of at least one engineer-generated document from the engineer-generated document(s) includes a number of links that is greater than or equal to a threshold number.

At step 204, weights are assigned to the respective features. For example, each weight may represent an importance of the respective feature. In another example, each weight may represent a ranking of the respective feature with reference to the other features. In an aspect, the weights may be assigned using a model, machine learning, rules, and/or heuristics. It will be recognized that the model may be any suitable type of model. For instance, the model may be a regression model or a classification model. Examples of a regression model include but are not limited to a linear regression model, a nonlinear regression model, a polynomial regression model, and a logistic regression model. In another aspect, the weights may be assigned manually. For instance, the weights may be assigned equally among the features such that each feature has the same weight as each other feature.

In an example embodiment, the weights are assigned to the respective features based at least in part on key performance indicators associated with the engineer-generated documentation. Each key performance indicator specifies an extent to which a respective engineer-generated document from the engineer-generated document(s) satisfies one or more criteria. One example criterion is that quality of the engineer-generated document is greater than or equal to a threshold quality. Quality of an engineer-generated document may be derived from attributes of the engineer-generated document and/or features with which the engineer-generated document is associated. Another example criterion is that an extent to which the engineer-generated document is used by users is greater than or equal to a threshold extent of usage. The extent to which an engineer-generated document is used may be based at least in part on an amount of time that the engineer-generated document is opened by users of the engineer-generated document, a number of users who access the document, and/or an amount of time that the users dwell on the engineer-generated document. Yet another example criterion is that coverage of the engineer-generated document is greater than or equal to a coverage threshold. Coverage of an engineer-generated document indicates a number of issues that the engineer-generated document is configured to be used to resolve or has been used to resolve in the past.

In an example implementation, the weight assignment logic 314 assigns weights to the respective features 344. For example, the weight assignment logic 314 may assign the weights to the respective features 344 using a model 322 based at least in part on key performance indicators 342 associated with the engineer-generated documentation. In accordance with this example, the weight assignment logic 314 may use the model 322 to analyze (e.g., perform regression analysis or classification analysis on) the key performance indicators 342 to predict or forecast the weights that are to be assigned to the respective features 344. In further accordance with this example, the weight assignment logic 314 may retrieve the key performance indicators 342 from the store 310 so that the key performance indicators 342 may be analyzed. The weight assignment logic 314 may generate weight information 346 in response to assigning the weights to the respective features 344. For instance, the weight information 346 may specify the weights and cross-reference the weights with the respective features 344.

At step 206, the quality-based action(s) regarding the engineer-generated documentation are performed based at least in part on the weights that are assigned to the respective features. A quality-based action regarding the engineer-generated documentation is performed with regard to at least one engineer-generated document that is included in the engineer-generated documentation. A quality-based action regarding an engineer-generated document in the engineer-generated documentation indicates (e.g., identifies) quality of the engineer-generated document and/or facilitates increasing the quality. The quality of an engineer-generated document represents a degree of excellence of the engineer-generated document or a superiority in kind of the engineer-generated document. The quality of the engineer-generated document may be based on any of a variety of factors, including but not limited to utility, ease of use (e.g., clarity, conciseness), reputation (e.g., among users of the engineer-generated document), and accuracy of the engineer-generated document. Some examples of a quality-based action are described in further detail below. In an example implementation, the performance logic 316 performs the quality-based action(s) regarding the engineer-generated documentation based at least in part on the weights that are assigned to the respective features 344, as specified by the weight information 346.

Step 206 includes steps 208, 210, 212, 214, 216, and 218. At step 208, a determination is made whether quality score(s) are to be generated for the respective engineer-generated document(s). If the quality score(s) are to be generated, flow continues to step 210. Otherwise, flow continues to step 212 shown in FIG. 2B. In an example implementation, the determination logic 324 determines whether quality score(s) 348 are to be generated for the respective engineer-generated document(s). In an action example, the determination logic 324 may analyze the features and the weights that are assigned to the respective features 344 to determine whether action(s) are to be performed. For instance, the determination logic 324 may determine that no action is to be performed as a result of the features 344 and the weights not satisfying designated condition(s). The determination logic 324 may determine that the action(s) are to be performed as a result of the features 344 and the weights satisfying the designated condition(s). In accordance with the action example, the determination logic 324 may review a setting to determine which action(s) are to be performed as a result of the features 344 and the weights satisfying the designated condition(s). If the designated condition(s) are satisfied and the setting indicates that the quality score(s) 348 are to be generated as a result of the designated condition(s) being satisfied, the determination logic 324 generates a score instruction 340. The score instruction 340 instructs the score logic 326 to generate the quality score(s) 348. If the designated condition(s) are not satisfied and/or the setting does not indicate that the quality score(s) 348 are to be generated as a result the designated condition(s) being satisfied, the determination logic 324 does not generate the score instruction 340, and the quality score(s) 348 are therefore not generated.

At step 210, the quality score(s) for the respective engineer-generated document(s) are generated. Each quality score is based at least in part on the weights assigned to the respective features that correspond to the respective engineer-generated document. Each quality score represents a quality of the respective engineer-generated document. Upon completion of step 210, flow continues to step 212 shown in FIG. 2B. In an example implementation, the score logic 326 generates the quality score(s) 348 for the respective engineer-generated document(s). For instance, the score logic 326 may generate the quality score(s) 348 based on receipt of the score instruction 340.

At step 212, a determination is made whether a recommendation is to be provided. If the recommendation is to be provided, flow continues to step 214. Otherwise, flow continues to step 216. In an example implementation, the determination logic 324 determines whether a recommendation 352 is to be provided. In accordance with the action example mentioned above with reference to step 208, if the designated condition(s) are satisfied and the setting indicates that the recommendation 352 is to be provided as a result of the designated condition(s) being satisfied, the determination logic 324 generates a recommendation instruction 336. The recommendation instruction 336 instructs the recommendation logic 330 to provide the recommendation 352. If the designated condition(s) are not satisfied and/or the setting does not indicate that the recommendation 352 is to be provided as a result the designated condition(s) being satisfied, the determination logic 324 does not generate the recommendation instruction 336, and the recommendation 352 is therefore not provided.

At step 214, the recommendation to revise a subset of the engineer-generated document(s) is provided based at least in part on the weights assigned to the respective features that correspond to the subset. The subset of the engineer-generated document(s) includes one or more of the engineer-generated document(s). For example, the subset may include all of the engineer-generated document(s). In another example, the subset may include fewer than all of the engineer-generated document(s). The recommendation recommends performance of an operation that is configured to increase quality of each engineer-generated document in the subset. In an example implementation, the recommendation logic 330 provides the recommendation 352, which recommends revising the subset of the engineer-generated document(s). For instance, the recommendation logic 330 may provide the recommendation 352 based on receipt of the recommendation instruction 336.

At step 216, a determination is made whether criteria satisfaction information is to be provided. If the criteria satisfaction information is to be provided, flow continues to step 218. Otherwise, flowchart 200 ends. In an example implementation, the determination logic 324 determines whether criteria satisfaction information 350 is to be provided. In accordance with the action example mentioned above with reference to steps 208 and 212, if the designated condition(s) are satisfied and the setting indicates that the criteria satisfaction information 350 is to be provided as a result of the designated condition(s) being satisfied, the determination logic 324 generates a criteria satisfaction instruction 338. The criteria satisfaction instruction 338 instructs the criteria satisfaction logic 328 to provide the criteria satisfaction information 350. If the designated condition(s) are not satisfied and/or the setting does not indicate that the criteria satisfaction information 350 is to be provided as a result the designated condition(s) being satisfied, the determination logic 324 does not generate the criteria satisfaction instruction 338, and the criteria satisfaction information 350 is therefore not provided.

At step 218, the criteria satisfaction information regarding at least one engineer-generated document from the engineer-generated document(s) is provided. Key performance indicators are associated with the engineer-generated documentation such that each key performance indicator specifies an extent to which a respective engineer-generated document from the engineer-generated document(s) satisfies one or more criteria. The criteria satisfaction information indicates whether each of the at least one engineer-generated document satisfies the one or more criteria associated with each key performance indicator associated with the respective engineer-generated document. Upon completion of step 218, flowchart 200 ends. In an example implementation, the criteria satisfaction logic 328 provides the criteria satisfaction information 350 regarding the at least one engineer-generated document. For instance, the criteria satisfaction logic 328 may provide the criteria satisfaction information 350 based on receipt of the criteria satisfaction instruction 338.

In some example embodiments, one or more steps 202, 204, 206, 208, 210, 212, 214, 216, and/or 218 of flowchart 200 may not be performed. Moreover, steps in addition to or in lieu of steps 202, 204, 206, 208, 210, 212, 214, 216, and/or 218 may be performed.

It will be recognized that the computing system 300 may not include one or more of the quality-based action logic 308, the store 310, the feature extraction logic 312, the weight assignment logic 314, the performance logic 316, the machine learning logic 318, the natural language processor 320, the determination logic 324, the score logic 326, the criteria satisfaction logic 328, and/or the recommendation logic 330. Furthermore, the computing system 300 may include components in addition to or in lieu of the quality-based action logic 308, the store 310, the feature extraction logic 312, the weight assignment logic 314, the performance logic 316, the machine learning logic 318, the natural language processor 320, the determination logic 324, the score logic 326, the criteria satisfaction logic 328, and/or the recommendation logic 330.

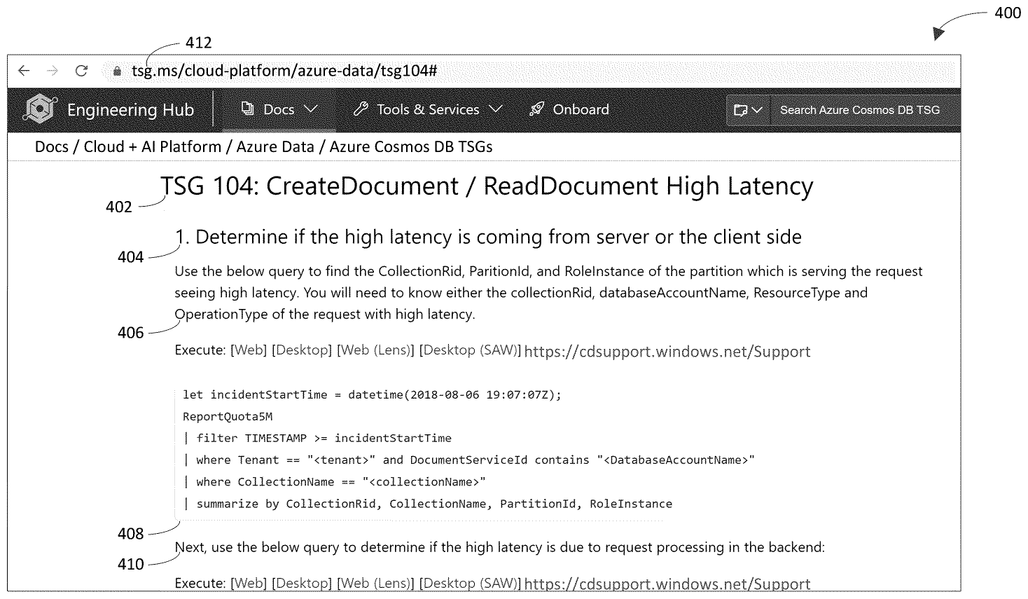

FIG. 4 depicts an example troubleshooting guide 400 associated with a database, which is implemented in code, in accordance with an embodiment. As shown in FIG. 4, the troubleshooting guide 400 includes identifying information 402. The identifying information 402 indicates that the troubleshooting guide 400 has been assigned number “104” and is named “CreateDocument/ReadDocument High Latency.” The troubleshooting guide 400 further includes a goal statement 404, a first instruction 406, code 408, and a second instruction 410. The goal statement 404 indicates a goal or a purpose that is to be achieved using the first and second instructions 406 and 410 and the code 408. The goal statement reads, “1. Determine if the high latency is coming from server or the client side.” The first instruction reads, “Use below query to find the CollectionRid, PartitionId, and RoleINstance of the partition which is serving the request seeing high latency. You need to know either the collectionRid, databaseAccountName, ResourceType and OperationType of the request with high latency.” The code 408 includes the query mentioned in the first instruction 406. The second instruction 410 reads, “Next, use the below query to determine if the high latency is due to request processing in the backend:” The query mentioned in the second instruction 410 is not shown.

The troubleshooting guide 400 is shown to be included in a graphical user interface (GUI) in FIG. 4 for illustrative purposes. The GUI includes a uniform resource locator (URL) 412 to indicate a location at which the troubleshooting guide 400 is stored.

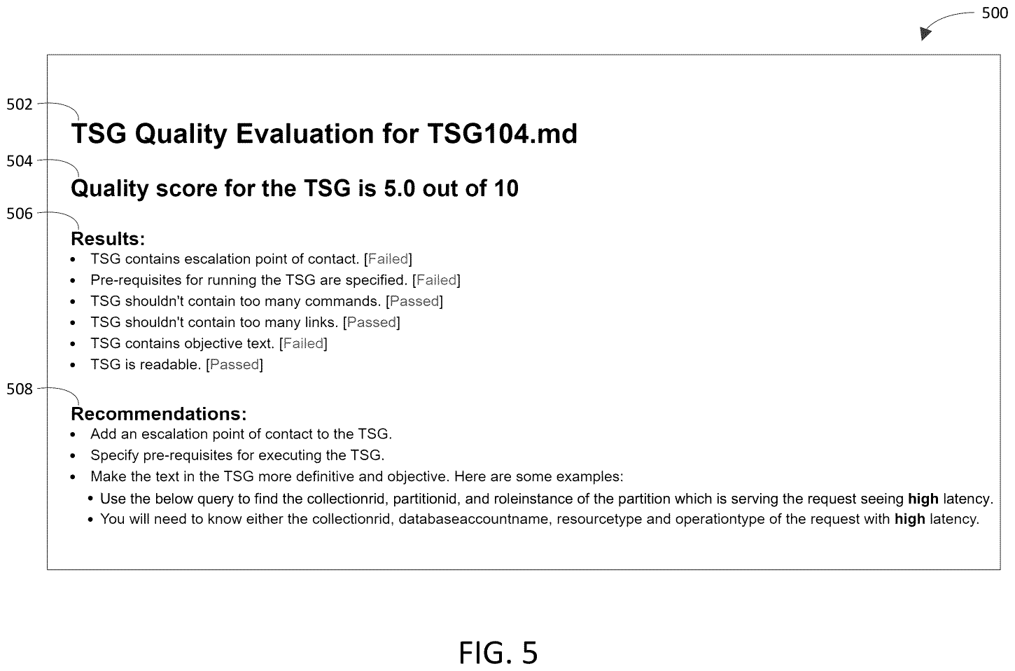

FIG. 5 depicts an example result 500 of performing quality-based actions regarding the troubleshooting guide 400 shown in FIG. 4 in accordance with an embodiment. As shown in FIG. 5, the results 500 include a title 502, a score statement 504, criteria satisfaction information 506, and recommendations 508. The title 502 identifies the troubleshooting guide 400 and reads, “TSG Quality Evaluation for TSG104.md.” The score statement 504 indicates a score that has been assigned to the troubleshooting guide 400 to indicate quality of the troubleshooting guide 400. The score statement 504 reads, “Quality score for the TSG is 5.0 out of 10.” For instance, the score of 5.0 out of 10 may indicate that the troubleshooting guide 400 satisfies the criteria for half of the key performance indicators that are associated with the troubleshooting guide 400.

The criteria satisfaction information 506 describes the key performance indicators associated with the troubleshooting guide 400 and whether the troubleshooting guide 400 satisfies the criteria associated with each of the key performance indicators. As described by the criteria satisfaction information 506, a first key performance indicator associated with the troubleshooting guide 400 requires that the troubleshooting guide 400 contains an escalation point of contact. A second key performance indicator associated with the troubleshooting guide 400 requires that pre-requisites for running the troubleshooting guide 400 are specified. A third key performance indicator associated with the troubleshooting guide 400 requires that the troubleshooting guide 400 should not contain too many commands. A fourth key performance indicator associated with the troubleshooting guide 400 requires that the troubleshooting guide 400 should not contain too many links. A fifth key performance indicator associated with the troubleshooting guide 400 requires that the troubleshooting guide 400 contains objective text. A sixth key performance indicator associated with the troubleshooting guide 400 requires that the troubleshooting guide 400 is readable. The criteria satisfaction information 506 indicates that the criteria associated with the first, second, and fifth key performance indicators are not satisfied. The criteria satisfaction information 506 further indicates that the criteria associated with the third, fourth, and sixth key performance indicators are satisfied.

The recommendations 508 include first, second, and third recommendations. The first recommendation is to add an escalation point of contact to the troubleshooting guide 400. The second recommendation is to specify pre-requisites for executing the troubleshooting guide 400. The third recommendation is to make the text in the troubleshooting guide 400 more definitive and objective. The third recommendation includes two examples. The first example reads, “Use the below query to find the collectionrid, partitionid, and roleinstance of the partition which is serving the request seeing high latency.” The query mentioned in the first example is not shown. The second example reads, “You will need to know either the collectionrid, databaseaccountname, resourcetype and operationtype of the request with high latency.”

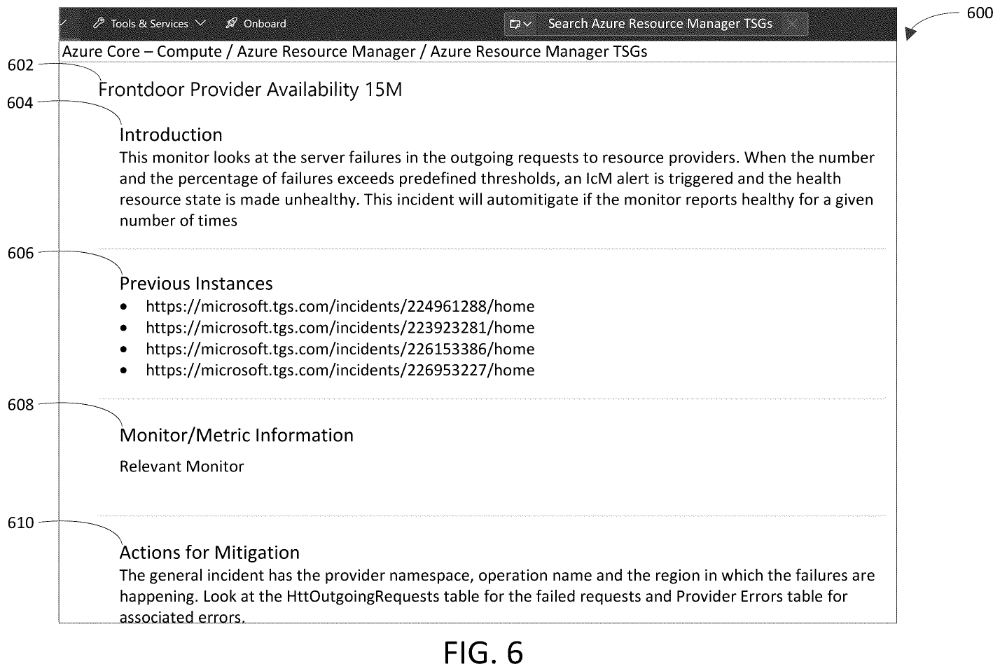

FIG. 6 depicts another example troubleshooting guide 600 associated with a monitor, which is implemented in code, in accordance with an embodiment. As shown in FIG. 6, the troubleshooting guide 600 includes identifying information 602. The identifying information 602 indicates that the troubleshooting guide 600 is named “Frontdoor Provider Availability 15M.” The troubleshooting guide 600 further includes an introduction 604, which reads, “This monitor looks at the server failures in the outgoing requests to resource providers. When the number and the percentage of failures exceeds predefined thresholds, an IcM alert is triggered and the health resource state is made unhealthy. This incident will automitigate if the monitor reports healthy for a given number of times.”

The troubleshooting guide 600 identifies previous instances 606 of server failures, which are identified by respective URLs. For instance, information regarding a first server failure is shown to be located at a destination corresponding to the following URL: https colon forward-slash forward-slash microsoft dot tgs dot com forward-slash incidents forward-slash 224961288 forward-slash home. Information regarding a second server failure is shown to be located at a destination corresponding to the following URL: https colon forward-slash forward-slash microsoft dot tgs dot com forward-slash incidents forward-slash 223923281 forward-slash home. Information regarding a third server failure is shown to be located at a destination corresponding to the following URL: https colon forward-slash forward-slash microsoft dot tgs dot com forward-slash incidents forward-slash 226153386 forward-slash home. Information regarding a fourth server failure is shown to be located at a destination corresponding to the following URL: https colon forward-slash forward-slash microsoft dot tgs dot com forward-slash incidents forward-slash 226953227 forward-slash home.

The troubleshooting guide 600 further includes monitor/metric information 608, which identifies the monitor with which the troubleshooting guide 600 is associated. The troubleshooting guide 600 identifies actions for mitigation 610. The actions for mitigation 610 include a recommendation, which reads, “The general incident has the provider namespace, operation name and the region in which the failures are happening. Look at the HttOutgoingRequests table for the failed requests and Provider Errors table for associated errors.”

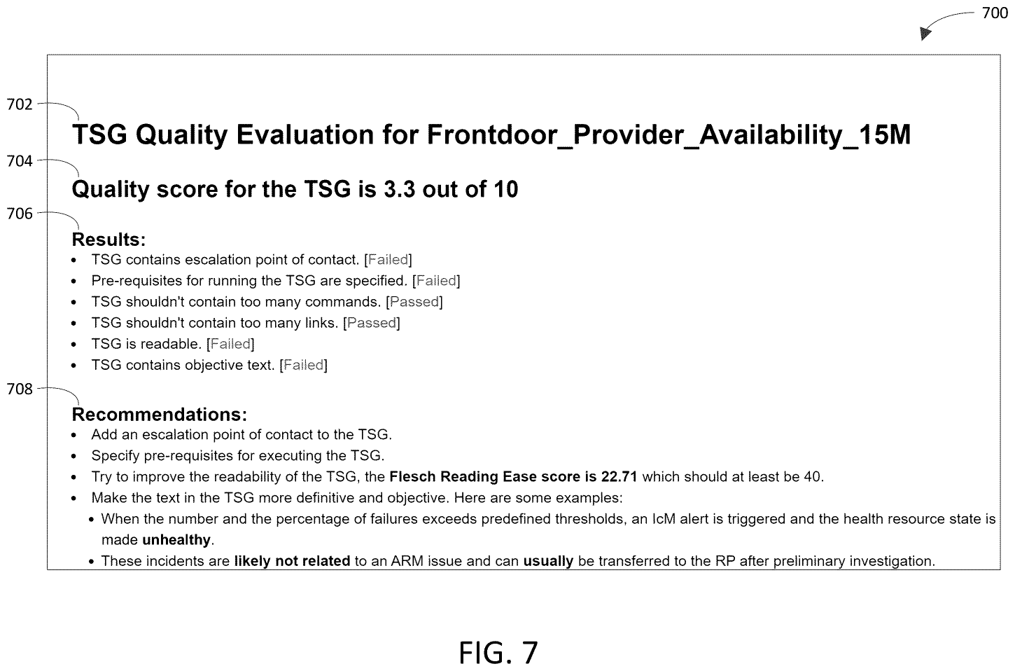

FIG. 7 depicts an example result 700 of performing quality-based actions regarding the troubleshooting guide 600 shown in FIG. 6 in accordance with an embodiment. As shown in FIG. 7, the results 700 include a title 702, a score statement 704, criteria satisfaction information 706, and recommendations 708. The title 702 identifies the troubleshooting guide 600 and reads, “TSG Quality Evaluation for Frontdoor_Provider_Availability_15M.” The score statement 704 indicates a score that has been assigned to the troubleshooting guide 600 to indicate quality of the troubleshooting guide 600. The score statement 604 reads, “Quality score for the TSG is 3.3 out of 10.” For instance, the score of 3.3 out of 10 may indicate that the troubleshooting guide 600 satisfies the criteria for approximately one-third of the key performance indicators that are associated with the troubleshooting guide 600.

The criteria satisfaction information 706 describes the key performance indicators associated with the troubleshooting guide 600 and whether the troubleshooting guide 600 satisfies the criteria associated with each of the key performance indicators. As described by the criteria satisfaction information 706, a first key performance indicator associated with the troubleshooting guide 600 requires that the troubleshooting guide 600 contains an escalation point of contact. A second key performance indicator associated with the troubleshooting guide 600 requires that pre-requisites for running the troubleshooting guide 600 are specified. A third key performance indicator associated with the troubleshooting guide 600 requires that the troubleshooting guide 600 should not contain too many commands. A fourth key performance indicator associated with the troubleshooting guide 600 requires that the troubleshooting guide 600 should not contain too many links. A fifth key performance indicator associated with the troubleshooting guide 600 requires that the troubleshooting guide 600 is readable. A sixth key performance indicator associated with the troubleshooting guide 600 requires that the troubleshooting guide 600 contains objective text. The criteria satisfaction information 706 indicates that the criteria associated with the first, second, fifth, and sixth key performance indicators are not satisfied. The criteria satisfaction information 706 further indicates that the criteria associated with the third and fourth key performance indicators are satisfied.

The recommendations 708 include first, second, third, and fourth recommendations. The first recommendation is to add an escalation point of contact to the troubleshooting guide 600. The second recommendation is to specify pre-requisites for executing the troubleshooting guide 600. The third recommendation is to try to improve the readability of the troubleshooting guide 600. The third recommendation indicates that the Flesch Reading Ease score for the troubleshooting guide 600 is 22.71 and further indicates that the Flesch Reading Ease score should be at least 40. The fourth recommendation is to make the text in the troubleshooting guide 600 more definitive and objective. The fourth recommendation includes two examples. The first example reads, “When the number and the percentage of failures exceeds predefined thresholds, an IcM alert is triggered and the health resource state is made unhealthy.” The second example reads, “These incidents are likely not related to an ARM issue and can usually be transferred to the RP after preliminary investigation.”

The troubleshooting guides 400 and 600 shown in respective FIGS. 4 and 6 and the results shown in respective FIGS. 5 and 7 are provided for illustrative purposes and are not intended to be limiting. It will be recognized that the techniques described herein are applicable to any suitable code and any suitable API.

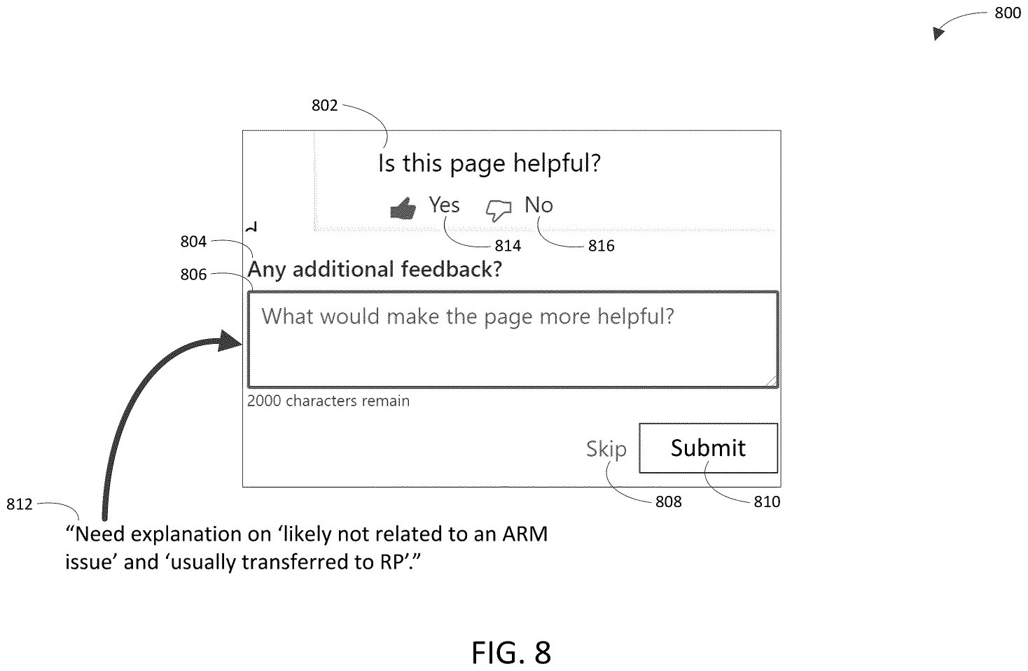

FIG. 8 depicts an example graphical user interface (GUI) 800 that solicits explicit feedback from a user of an engineer-generated document in accordance with an embodiment. The GUI 800 includes a first solicitation 802, which reads, “Is this page helpful?” The page to which the first solicitation 802 refers is a page that includes the engineer-generated document. A “Yes” interface element 814 and a “No” interface element 816 are associated with the first solicitation 802. Each of the “Yes” interface element 814 and the “No” interface element 816 is selectable by the user to indicate the corresponding response to the first solicitation 802. The GUI 800 further includes a second solicitation 804, which reads, “Any additional feedback?” The GUI 800 further includes a text box 806 in which the user may type any additional feedback that the user may have up to 2000 characters. For instance, FIG. 8 indicates that the user types, “Need explanation on ‘likely not related to an ARM issue’ and ‘usually transferred to RP’” in the text box 806. The GUI 800 further includes a “Skip” button 808 and a “Submit” button 810. The “Skip” button is selectable by the user to enable the user to avoid providing feedback regarding the engineer-generated document. For instance, selection of the “Skip” button 808 may cause the GUI 800 to close (e.g., disappear). The “Submit” button 810 is selectable by the user to enable the user to submit feedback that the user may have provided in the text box 806 and/or using either of the interface elements 814 and 816.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the quality-based action logic 108, the quality-based action logic 308, the feature extraction logic 312, the weight assignment logic 314, the performance logic 316, the machine learning logic 318, the natural language processor 320, the determination logic 324, the score logic 326, the criteria satisfaction logic 328, the recommendation logic 330, and/or flowchart 200 may be implemented in hardware, software, firmware, or any combination thereof.

For example, any one or more of the quality-based action logic 108, the quality-based action logic 308, the feature extraction logic 312, the weight assignment logic 314, the performance logic 316, the machine learning logic 318, the natural language processor 320, the determination logic 324, the score logic 326, the criteria satisfaction logic 328, the recommendation logic 330, and/or flowchart 200 may be implemented, at least in part, as computer program code configured to be executed in one or more processors.

In another example, any one or more of the quality-based action logic 108, the quality-based action logic 308, the feature extraction logic 312, the weight assignment logic 314, the performance logic 316, the machine learning logic 318, the natural language processor 320, the determination logic 324, the score logic 326, the criteria satisfaction logic 328, the recommendation logic 330, and/or flowchart 200 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### III. Further Discussion of Some Example Embodiments

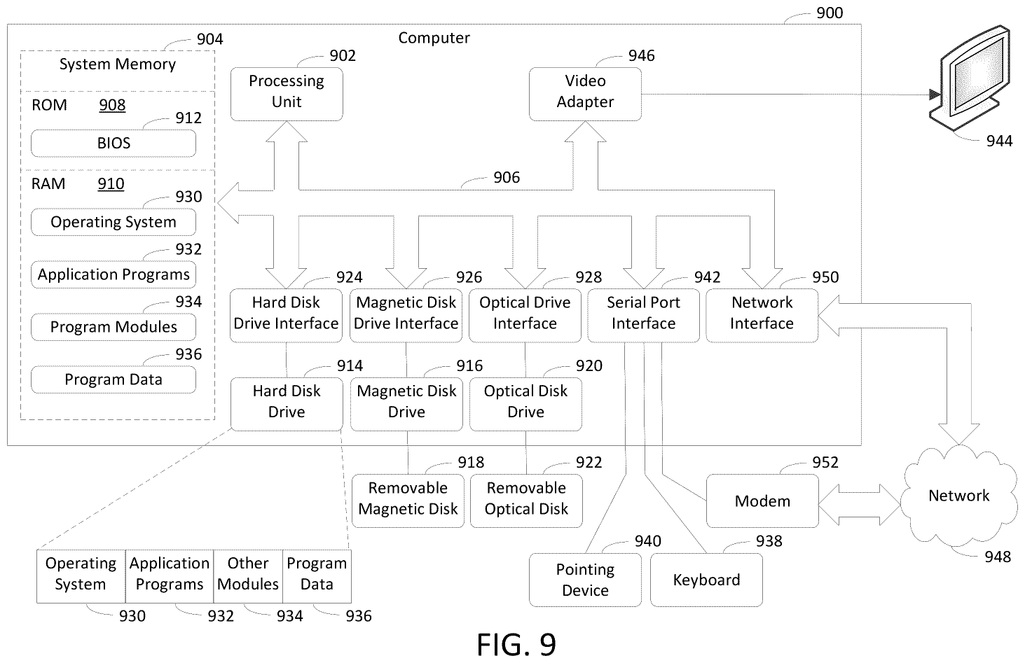

(A1) An example system (FIG. 1, 102A-102M, 106A-106N; FIG. 3, 300; FIG. 9, 900) comprises a memory (FIG. 9, 904, 908, 910) and one or more processors (FIG. 9, 902) coupled to the memory. The one or more processors are configured to extract (FIG. 2A, 202) features (FIG. 3, 344) from data (FIG. 3, 334) associated with engineer-generated documentation that is associated with at least one of code or an application programming interface (API). The engineer-generated documentation includes one or more engineer-generated documents. Each feature indicates an attribute of at least one engineer-generated document from the one or more engineer-generated documents. The one or more processors are further configured to assign (FIG. 2A, 204) weights to the respective features. The one or more processors are further configured to perform (FIG. 2A, 206) at least one quality-based action regarding the engineer-generated documentation based at least in part on the weights that are assigned to the respective features. The at least one quality-based action includes at least one of: generating (FIG. 2A, 210) one or more quality scores (FIG. 3, 348) for the respective one or more engineer-generated documents; providing (FIG. 2B, 214) a recommendation (FIG. 3, 352) to revise a subset of the one or more engineer-generated documents based at least in part on the weights assigned to the respective features that correspond to the subset of the one or more engineer-generated documents. Each quality score is based at least in part on the weights assigned to the respective features that correspond to the respective engineer-generated document. Each quality score represents a quality of the respective engineer-generated document. The recommendation recommends performance of an operation that is configured to increase the quality of each engineer-generated document in the subset.
(A2) In the example system of A1, wherein the one or more processors are configured to: assign the weights to the respective features using a model based at least in part on key performance indicators associated with the engineer-generated documentation, each key performance indicator specifying an extent to which a respective engineer-generated document from the one or more engineer-generated documents satisfies one or more criteria; and provide criteria satisfaction information regarding an engineer-generated document from the one or more engineer-generated documents, the criteria satisfaction information indicating whether the engineer-generated document satisfies the one or more criteria associated with each key performance indicator associated with the engineer-generated document.
(A3) In the example system of any of A1-A2, wherein the one or more engineer-generated documents are one or more troubleshooting guides, each troubleshooting guide including instructions that describe operations to be performed to resolve issues associated with the at least one of the code or the API.
(A4) In the example system of any of A1-A3, wherein the one or more processors are configured to extract the features from the data associated with the engineer-generated documentation that is stored across multiple independent clouds.
(A5) In the example system of any of A1-A4, wherein the one or more processors are configured to execute code that is included in an engineer-generated document that is included in the engineer-generated documentation to extract at least one of the features from the data associated with the engineer-generated documentation.
(A6) In the example system of any of A1-A5, wherein the one or more processors are configured to extract the features from the data using a machine learning model, the machine learning model configured to receive the data as input to the machine learning model and further configured to derive the features as outputs of the machine learning model based on the data.
(A7) In the example system of any of A1-A6, wherein the one or more processors are configured to extract a feature that indicates a readability of each of at least one engineer-generated document from the one or more engineer-generated documents.
(A8) In the example system of any of A1-A7, wherein the one or more processors are configured to extract a feature that indicates a number of users who use each of at least one engineer-generated document from the one or more engineer-generated documents.
(A9) In the example system of any of A1-A8, wherein the one or more processors are configured to extract a feature that indicates a number of times each of at least one engineer-generated document from the one or more engineer-generated documents is viewed.
(A10) In the example system of any of A1-A9, wherein the one or more processors are configured to extract a feature that indicates an amount of time that users of each of at least one engineer-generated document from the one or more engineer-generated documents dwell on the respective engineer-generated document.
(A11) In the example system of any of A1-A10, wherein the one or more processors are configured to extract a feature that indicates an extent to which users of each of at least one engineer-generated document from the one or more engineer-generated documents scroll on the respective engineer-generated document.
(A12) In the example system of any of A1-A11, wherein the one or more processors are configured to extract a feature that indicates an extent to which language in each of at least one engineer-generated document from the one or more engineer-generated documents is subjective by analyzing the data that is included in the respective engineer-generated document using natural language processing.
(A13) In the example system of any of A1-A12, wherein the one or more processors are configured to extract a feature that indicates an amount of time since each of at least one engineer-generated document from the one or more engineer-generated documents was created or updated.
(A14) In the example system of any of A1-A13, wherein the one or more processors are configured to extract a feature that indicates explicit feedback regarding each of at least one engineer-generated document from the one or more engineer-generated documents from users of the respective engineer-generated document.
(A15) In the example system of any of A1-A14, wherein the one or more processors are configured to extract a feature that indicates that at least one engineer-generated document from the one or more engineer-generated documents is empty.
(A16) In the example system of any of A1-A15, wherein the one or more processors are configured to extract a feature that indicates that at least one engineer-generated document from the one or more engineer-generated documents has a length that is greater than or equal to a length threshold.
(A17) In the example system of any of A1-A16, wherein the one or more processors are configured to extract a feature that indicates whether an engineer-generated document from the one or more engineer-generated documents includes contact information of a person or a group of persons to be contacted for assistance with the engineer-generated document.
(A18) In the example system of any of A1-A17, wherein the one or more processors are configured to extract a feature that indicates whether each of at least one engineer-generated document from the one or more engineer-generated documents includes a number of commands that is greater than or equal to a threshold number.
(A19) In the example system of any of A1-A18, wherein the one or more processors are configured to extract a feature that indicates whether each of at least one engineer-generated document from the one or more engineer-generated documents includes a number of links that is greater than or equal to a threshold number.
(B1) An example method, which is implemented by a computing system (FIG. 1, 102A-102M, 106A-106N; FIG. 3, 300; FIG. 9, 900), comprises extracting (FIG. 2A, 202) features (FIG. 3, 344) from data (FIG. 3, 334) associated with engineer-generated documentation that is associated with at least one of code or an application programming interface (API). The engineer-generated documentation includes one or more engineer-generated documents. Each feature indicates an attribute of at least one engineer-generated document from the one or more engineer-generated documents. The method further comprises assigning (FIG. 2A, 204) weights to the respective features. The method further comprises performing (FIG. 2A, 206) at least one quality-based action regarding the engineer-generated documentation based at least in part on the weights that are assigned to the respective features. The at least one quality-based action includes at least one of: generating (FIG. 2A, 210) one or more quality scores (FIG. 3, 348) for the respective one or more engineer-generated documents; providing (FIG. 2B, 214) a recommendation (FIG. 3, 352) to revise a subset of the one or more engineer-generated documents based at least in part on the weights assigned to the respective features that correspond to the subset of the one or more engineer-generated documents. Each quality score is based at least in part on the weights assigned to the respective features that correspond to the respective engineer-generated document. Each quality score represents a quality of the respective engineer-generated document. The recommendation recommends performance of an operation that is configured to increase the quality of each engineer-generated document in the subset.
(B2) In the method of B1, wherein assigning the weights to the respective features comprises: assigning the weights to the respective features using a model based at least in part on key performance indicators associated with the engineer-generated documentation, each key performance indicator specifying an extent to which a respective engineer-generated document from the one or more engineer-generated documents satisfies one or more criteria; and wherein performing the at least one quality-based action regarding the engineer-generated documentation comprises: generating the one or more quality scores for the respective one or more engineer-generated documents; and providing criteria satisfaction information regarding an engineer-generated document from the one or more engineer-generated documents, the criteria satisfaction information indicating whether the engineer-generated document satisfies the one or more criteria associated with each key performance indicator associated with the engineer-generated document.
(B3) In the method of any of B1-B2, wherein the one or more engineer-generated documents are one or more troubleshooting guides, each troubleshooting guide including instructions that describe operations to be performed to resolve issues associated with the at least one of the code or the API.
(B4) In the method of any of B1-B3, wherein extracting the features comprises: extracting the features from the data associated with the engineer-generated documentation that is stored across multiple independent clouds.
(B5) In the method of any of B1-B4, wherein extracting the features from the data associated with the engineer-generated documentation comprises: executing code that is included in an engineer-generated document that is included in the engineer-generated documentation to extract at least one of the features from the data associated with the engineer-generated documentation.
(B6) In the method of any of B1-B5, wherein extracting the features from the data associated with the engineer-generated documentation comprises: extracting the features from the data using a machine learning model, the machine learning model configured to receive the data as input to the machine learning model and further configured to derive the features as outputs of the machine learning model based on the data.
(B7) In the method of any of B1-B6, wherein extracting the features from the data associated with the engineer-generated documentation comprises: extracting a feature that indicates a readability of each of at least one engineer-generated document from the one or more engineer-generated documents.
(B8) In the method of any of B1-B7, wherein extracting the features from the data associated with the engineer-generated documentation comprises: extracting a feature that indicates a number of users who use each of at least one engineer-generated document from the one or more engineer-generated documents.
(B9) In the method of any of B1-B8, wherein extracting the features from the data associated with the engineer-generated documentation comprises: extracting a feature that indicates a number of times each of at least one engineer-generated document from the one or more engineer-generated documents is viewed.
(B10) In the method of any of B1-B9, wherein extracting the features from the data associated with the engineer-generated documentation comprises: extracting a feature that indicates an amount of time that users of each of at least one engineer-generated document from the one or more engineer-generated documents dwell on the respective engineer-generated document.
(B11) In the method of any of B1-B10, wherein extracting the features from the data associated with the engineer-generated documentation comprises: extracting a feature that indicates an extent to which users of each of at least one engineer-generated document from the one or more engineer-generated documents scroll on the respective engineer-generated document.
(B12) In the method of any of B1-B11, wherein extracting the features from the data associated with the engineer-generated documentation comprises: extracting a feature that indicates an extent to which language in each of at least one engineer-generated document from the one or more engineer-generated documents is subjective by analyzing the data that is included in the respective engineer-generated document using natural language processing.
(B13) In the method of any of B1-B12, wherein extracting the features from the data associated with the engineer-generated documentation comprises: extracting a feature that indicates an amount of time since each of at least one engineer-generated document from the one or more engineer-generated documents was created or updated.
(B14) In the method of any of B1-B13, wherein extracting the features from the data associated with the engineer-generated documentation comprises: extracting a feature that indicates explicit feedback regarding each of at least one engineer-generated document from the one or more engineer-generated documents from users of the respective engineer-generated document.
(B15) In the method of any of B1-B14, wherein extracting the features from the data associated with the engineer-generated documentation comprises: extracting a feature that indicates that at least one engineer-generated document from the one or more engineer-generated documents is empty.
(B16) In the method of any of B1-B15, wherein extracting the features from the data associated with the engineer-generated documentation comprises: extracting a feature that indicates that at least one engineer-generated document from the one or more engineer-generated documents has a length that is greater than or equal to a length threshold.
(B17) In the method of any of B1-B16, wherein extracting the features from the data associated with the engineer-generated documentation comprises: extracting a feature that indicates whether an engineer-generated document from the one or more engineer-generated documents includes contact information of a person or a group of persons to be contacted for assistance with the engineer-generated document.
(B18) In the method of any of B1-B17, wherein extracting the features from the data associated with the engineer-generated documentation comprises: extracting a feature that indicates whether each of at least one engineer-generated document from the one or more engineer-generated documents includes a number of commands that is greater than or equal to a threshold number.
(B19) In the method of any of B1-B18, wherein extracting the features from the data associated with the engineer-generated documentation comprises: extracting a feature that indicates whether each of at least one engineer-generated document from the one or more engineer-generated documents includes a number of links that is greater than or equal to a threshold number.
(C1) An example computer program product (FIG. 9, 918, 922) comprising a computer-readable storage medium having instructions recorded thereon for enabling a processor-based system (FIG. 1, 102A-102M, 106A-106N; FIG. 3, 300; FIG. 9, 900) to perform at least one quality-based action regarding engineer-generated documentation by performing operations. The operations comprise extracting (FIG. 2A, 202) features (FIG. 3, 344) from data (FIG. 3, 334) associated with the engineer-generated documentation, which is associated with at least one of code or an application programming interface (API). The engineer-generated documentation includes one or more engineer-generated documents. Each feature indicates an attribute of at least one engineer-generated document from the one or more engineer-generated documents. The operations further comprise assigning (FIG. 2A, 204) weights to the respective features using a model (FIG. 3, 322) based at least in part on key performance indicators (FIG. 3, 342) associated with the engineer-generated documentation. Each key performance indicator specifies an extent to which a respective engineer-generated document from the one or more engineer-generated documents satisfies one or more criteria. The operations further comprise performing (FIG. 2A, 206) the at least one quality-based action regarding the engineer-generated documentation based at least in part on the weights that are assigned to the respective features. The at least one quality-based action includes at least one of: generating (FIG. 2A, 210) one or more quality scores (FIG. 3, 348) for the respective one or more engineer-generated documents; providing (FIG. 2B, 214) a recommendation (FIG. 3, 352) to revise a subset of the one or more engineer-generated documents based at least in part on the weights assigned to the respective features that correspond to the subset of the one or more engineer-generated documents. Each quality score is based at least in part on the weights assigned to the respective features that correspond to the respective engineer-generated document. Each quality score represents a quality of the respective engineer-generated document. The recommendation recommends performance of an operation that is configured to increase the quality of each engineer-generated document in the subset.

### IV. Example Computer System

FIG. 9 depicts an example computer 900 in which embodiments may be implemented. Any one or more of the user devices 102A-102M and/or any one or more of the servers 106A-106N shown in FIG. 1 and/or computing system 300 shown in FIG. 3 may be implemented using computer 900, including one or more features of computer 900 and/or alternative features. Computer 900 may be a general-purpose computing device in the form of a conventional personal computer, a mobile computer, or a workstation, for example, or computer 900 may be a special purpose computing device. The description of computer 900 provided herein is provided for purposes of illustration, and is not intended to be limiting. Embodiments may be implemented in further types of computer systems, as would be known to persons skilled in the relevant art(s).

As shown in FIG. 9, computer 900 includes a processing unit 902, a system memory 904, and a bus 906 that couples various system components including system memory 904 to processing unit 902. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computer 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 930, one or more application programs 932, other program modules 934, and program data 936. Application programs 932 or program modules 934 may include, for example, computer program logic for implementing any one or more of (e.g., at least a portion of) the quality-based action logic 108, the quality-based action logic 308, the feature extraction logic 312, the weight assignment logic 314, the performance logic 316, the machine learning logic 318, the natural language processor 320, the determination logic 324, the score logic 326, the criteria satisfaction logic 328, the recommendation logic 330, and/or flowchart 200 (including any step of flowchart 200), as described herein.

A user may enter commands and information into the computer 900 through input devices such as keyboard 938 and pointing device 940. Other input devices (not shown) may include a microphone, joystick, game pad, satellite dish, scanner, touch screen, camera, accelerometer, gyroscope, or the like. These and other input devices are often connected to the processing unit 902 through a serial port interface 942 that is coupled to bus 906, but may be connected by other interfaces, such as a parallel port, game port, or a universal serial bus (USB).

A display device 944 (e.g., a monitor) is also connected to bus 906 via an interface, such as a video adapter 946. In addition to display device 944, computer 900 may include other peripheral output devices (not shown) such as speakers and printers.

Computer 900 is connected to a network 948 (e.g., the Internet) through a network interface or adapter 950, a modem 952, or other means for establishing communications over the network. Modem 952, which may be internal or external, is connected to bus 906 via serial port interface 942.

As used herein, the terms “computer program medium” and “computer-readable storage medium” are used to generally refer to media (e.g., non-transitory media) such as the hard disk associated with hard disk drive 914, removable magnetic disk 918, removable optical disk 922, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 932 and other program modules 934) may be stored on the hard disk, magnetic disk, optical disk, ROM, or RAM. Such computer programs may also be received via network interface 950 or serial port interface 942. Such computer programs, when executed or loaded by an application, enable computer 900 to implement features of embodiments discussed herein. Accordingly, such computer programs represent controllers of the computer 900.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### V. Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

1. A system comprising:
a memory; and
a processing system coupled to the memory, the processing system configured to:
extract features from data associated with an engineer-generated document that is associated with at least one of code or an application programming interface (API), the features indicating respective attributes of the engineer-generated document;
assign weights to the respective features; and
provide a recommendation to revise the engineer-generated document based at least in part on the weights assigned to the respective features, the recommendation recommending performance of an operation that is configured to increase the quality of the engineer-generated document.

2. The system of claim 1, wherein the processing system is configured to:
assign the weights to the respective features using a model based at least in part on a key performance indicator associated with the engineer-generated document, the key performance indicator specifying an extent to which the engineer-generated document satisfies a criterion; and
provide criteria satisfaction information regarding the engineer-generated document, the criteria satisfaction information indicating whether the engineer-generated document satisfies the criterion associated with the key performance indicator.

3. The system of claim 1, wherein the engineer-generated document is a troubleshooting guide, the troubleshooting guide including instructions that describe operations to be performed to resolve issues associated with the at least one of the code or the API.

4. (canceled)

5. The system of claim 1, wherein the processing system is configured to:
execute code that is included in the engineer-generated document that is included to extract at least one of the features from the data associated with the engineer-generated document.

6. (canceled)

7. The system of claim 1, wherein the processing system is configured to:
extract a feature, which indicates a readability of the engineer-generated document, from the data associated with the engineer-generated document.

8. The system of claim 1, wherein the processing system is configured to:
extract a feature, which indicates a number of users who use the engineer-generated document, from the data associated with the engineer-generated document.

9. The system of claim 1, wherein the processing system is configured to:
extract a feature, which indicates a number of times the engineer-generated document is viewed, from the data associated with the engineer-generated document.

10. The system of claim 1, wherein the processing system is configured to:
extract a feature, which indicates an amount of time that users of the engineer-generated document dwell on the engineer-generated document, from the data associated with the engineer-generated document.

11. The system of claim 1, wherein the processing system is configured to:
extract a feature, which indicates an extent to which users of the engineer-generated document scroll on the engineer-generated document, from the data associated with the engineer-generated document.

12. A method, which is implemented by a computing system, comprises:
extracting features from data associated with an engineer-generated document that is associated with at least one of code or an application programming interface (API), the features indicating respective attributes of the engineer-generated document;
assigning weights to the respective features;
generating a quality score for the engineer-generated document, the quality score based at least in part on the weights assigned to the respective features, the quality score representing a quality of the engineer-generated document; and
providing a recommendation to revise the engineer-generated document based at least in part on the weights assigned to the respective features, the recommendation recommending performance of an operation that is configured to increase the quality of the engineer-generated document.

13. The method of claim 12, wherein extracting the features from the data associated with the engineer-generated document comprises:
extracting a feature, which indicates an extent to which language in the engineer-generated document is subjective, by analyzing the data that is included in the engineer-generated document using natural language processing.

14. The method of claim 12, wherein extracting the features from the data associated with the engineer-generated document comprises:
extracting a feature, which indicates an amount of time since the engineer-generated document was created or updated, from the data associated with the engineer-generated document.

15. The method of claim 12, wherein extracting the features from the data associated with the engineer-generated document comprises:
extracting a feature, which indicates explicit feedback regarding the engineer-generated document from users of the engineer-generated document, from the data associated with the engineer-generated document.

16. The method of claim 12, wherein extracting the features from the data associated with the engineer-generated document comprises:
extracting a feature, which indicates that the engineer-generated document is empty, from the data associated with the engineer-generated document.

17. The method of claim 12, wherein extracting the features from the data associated with the engineer-generated document comprises:
extracting a feature, which indicates that the engineer-generated document has a length that is greater than or equal to a length threshold, from the data associated with the engineer-generated document.

18. The method of claim 12, wherein extracting the features from the data associated with the engineer-generated document comprises:
extracting a feature, which indicates whether the engineer-generated document includes contact information of a person or a group of persons to be contacted for assistance with the engineer-generated document, from the data associated with the engineer-generated document.

19. The method of claim 12, wherein extracting the features from the data associated with the engineer-generated document comprises:
extracting a feature, which indicates whether the engineer-generated document includes a number of commands that is greater than or equal to a threshold number, from the data associated with the engineer-generated document.

20. The method of claim 12, wherein extracting the features from the data associated with the engineer-generated document comprises:
extracting a feature, which indicates whether the engineer-generated document includes a number of links that is greater than or equal to a threshold number, from the data associated with the engineer-generated document.

21. A computer program product comprising a computer-readable storage medium having instructions recorded thereon for enabling a processor-based system to perform a quality-based action regarding an engineer-generated document by performing operations, the operations comprising:
extracting features from data associated with the engineer-generated document, which is associated with at least one of code or an application programming interface (API), the features indicating respective attributes of the engineer-generated document;
assigning weights to the respective features using a model based at least in part on a key performance indicator associated with the engineer-generated document, the key performance indicator specifying an extent to which the engineer-generated document satisfies a criterion; and
providing a recommendation to revise the engineer-generated document based at least in part on the weights assigned to the respective features, the recommendation recommending performance of an operation that is configured to increase the quality of the engineer-generated document.

22. The computer program product of claim 21, wherein the criterion requires that quality of the engineer-generated document is greater than or equal to a threshold quality.

23. The computer program product of claim 21, wherein the criterion requires that an extent to which the engineer-generated document is used by users is greater than or equal to a threshold extent of usage.
